(19) United States
(12) Patent Application Publication
(10) Pub. No.: US 2014/0105315 A1
(43) Pub. Date: Apr. 17, 2014

(54) FREQUENCY TIME BLOCK MODULATION FOR MITIGATING DOUBLY-SELECTIVE FADING

(71) Applicant: THE GOVERNORS OF THE UNIVERSITY OF ALBERTA, Edmonton (CA)

(72) Inventors: Damith SENARATNE, San Diego, CA (US); Chintha TELLAMBURA, Edmonton (CA)

(73) Assignee: THE GOVERNORS OF THE UNIVERSITY OF ALBERTA, Edmonton (CA)

(21) Appl. No.: 14/052,131

(22) Filed: Oct. 11, 2013

Related U.S. Application Data
(60) Provisional application No. 61/712,968, filed on Oct. 12, 2012.

(51) Int. Cl. H04L 27/26

(52) U.S. Cl. CPC H04L 27/2602
USPC 375/260

(57) ABSTRACT

The present invention provides systems, methods, and devices for addressing the effects of doubly-selective fading channels. Data symbols to be transmitted are organized into blocks and a Fourier transform-based pre-processing method is then applied to the data blocks. Cyclic padding is then applied to the pre-processed blocks and each symbol in the padded block is then mapped to frequency subcarriers in specific time slots. The resulting signal is then transmitted through a wireless connection. At the receiver, the received signal is processed to thereby reverse the processing performed at the transmission end. As part of the reversal, a post-processing method is applied that reverses the effects of the pre-processing method.

### TECHNICAL FIELD

This invention relates to wireless communications systems. More specifically, the present invention relates to signal processing techniques for mitigating the adverse effects of doubly-selective fading.

### BACKGROUND OF THE INVENTION

The telecommunication revolution of the late 20th century and early 21st century has led to not just a boom in the cellular telephone industry but to the creation of a wireless communications industry. Wireless communications, whether it is through the use of a mobile telephone or an almost ubiquitous Wi-Fi connection, now pervade modern life. The demand for faster connectivity (e.g., to deliver interactive multimedia content) has made supporting higher data rates a key consideration in wireless communications; consequently, each generation of wireless communication technologies has introduced new signal-processing techniques to support higher data rates without compromising the reliability of communication.

Central to wireless communications is the ability to transmit data from the source wireless terminal (known as the transmitter) in the form of a radio signal and reliably recover the data at the destination terminal (known as the receiver) from the noisy and possibly distorted version of the signal received.

In a basic wireless transmitter, a modulator transforms the data to be transmitted into a sequence of complex-valued symbols as dictated by a particular modulation scheme. The phase and the amplitude of a radio frequency carrier are varied in successive time slots, based on, respectively, the angle and the absolute value of those symbols. The resulting radio frequency (RF) signal is amplified, up-converted to a desired frequency band, and transmitted over the wireless communication channel (or simply, the channel) which is the radio signal propagation medium existing between the wireless terminals. The basic receiver receives the transmitted signal, amplifies the received signal, and down-converts it back to the original frequency. The resulting signal is then equalized and fed to the detector.

The channel and the transmitter/receiver radio circuitry attenuate and/or amplify the signal, the cumulative effect of which is manifested as a complex channel gain. Various phenomena related to the wireless medium and the radio circuitry can also corrupt the received signal by introducing noise.

To address the channel gain and any corruption in the received signal, various techniques may be used. An equalizer uses channel state information (CSI), an estimate of the channel obtained through the channel-estimation process, to compensate for any channel-induced signal distortion. A detector then ascertains the transmitted data from the resulting signal, based on the modulation scheme employed at the transmitter. Since noise causes detection errors, the symbol error rate depends on the signal-to-noise ratio or the relative received signal strength compared to noise power. It should be noted that the symbol error rate or how often the symbols are erroneously detected is a measure by which reliability of the channel is quantified.

The channel gain fluctuates randomly, a phenomenon known as fading and this worsens the symbol error rate. The ideal fading channel has a flat response where all frequency components of the signal are equally affected. While there can be multiple radio signal propagation paths from the transmitter to the receiver, since the delays between paths are insignificant, the overall effect can be captured as a single channel gain. Therefore, with flat fading or with a flat response, the symbols can be recovered distortion-free by using single-tap equalization that merely compensates for the channel gain. An additional benefit of single-tap equalization is that it is inexpensive to implement.

However, at higher data rates, the relative delays among the multiple radio signal propagation paths become non-negligible when compared to the symbol duration, causing the delayed replicas of each symbol to interfere with the reception of subsequent symbols, a phenomenon known as inter-symbol interference. This transmission impairment is known as frequency-selective fading, because the signal has a broader signal bandwidth than the channel's coherence bandwidth, i.e., the range of frequencies over which a channel has a flat response. Equalization for frequency-selective fading requires multi-tap equalizers that have prohibitively high computational complexity.

Doppler frequency shifts induced by mobility cause time-selective fading (sometimes known as fast fading), which is characterized by the channel's coherence time being smaller than the symbol duration. For clarity, a channel's coherence time is the time duration over which the channel response is considered to be steady. The adverse effects of time-selective fading are manifested as inter-carrier interference in multicarrier communications systems. Multicarrier communication systems simultaneously transmit multiple frequency subcarriers with each subcarrier carrying an independent data stream.

If not properly compensated for, both frequency-selective and time-selective fading can severely reduce the reliability of communication. Higher data rates aggravate frequency-selective fading, while higher carrier frequencies and mobility worsen time-selective fading. Hence, combating doubly-selective fading (i.e., simultaneous frequency-selective and time-selective fading) is becoming increasingly important in wireless communications.

A wireless channel is regarded to undergo block fading if its fading characterization is consistent throughout a certain time interval and a frequency range. In particular, doubly-selective block fading occurs when the channel's fading characterization (e.g. the delay-Doppler spread function of the channel) is invariant within a reasonably large frequency-time block.

Exploited in the latest Wi-Fi, WiMAX, and 3GPP LTE standards, orthogonal frequency division multiplexing (OFDM) (see Pandharipande, A. (2002) Principles of OFDM. IEEE Potentials, 21(2):16-19) is a well-known technique for mitigating frequency-selective block fading. By splitting the data across a set of tightly spaced frequency subcarriers, OFDM renders lower the effective data rate per subcarrier, causing each OFDM symbol to have a longer duration. Because of this, the effective channel affecting each subcarrier becomes flat. By employing a cyclic prefix (i.e., by reusing the tail portion of each OFDM symbol to space that symbol apart from the previous OFDM symbol), OFDM makes the effective channel diagonalizable using Fourier Transform-based transmitter and receiver processing. In doing so, OFDM avoids inter-carrier interference (i.e., interference between the subcarriers).

However, even the slightest frequency shift breaks the orthogonality of the OFDM subcarriers and causes inter-carrier interference, making OFDM fragile under time-selective fading. Frequency-domain equalization applied on top of OFDM can suppress only a small amount of time-selective fading. Therefore, OFDM systems are typically designed to avoid time-selective fading by choosing subcarrier spacing to be an order of magnitude larger than the maximum anticipated Doppler shift. However, depending on the channel's coherence time, this practice restricts the maximum OFDM symbol duration as well as the maximum number of subcarriers possible in the system given a certain frequency band. Therefore, developing alternative signal processing techniques that are more robust against doubly-selective fading has great practical significance.

In light of the above, there is a need for systems and methods which reduce if not overcome the drawbacks of the prior art on reliable communication over doubly-selective fading channels.

### SUMMARY OF INVENTION

The present invention provides systems, methods, and devices for addressing the effects of doubly-selective fading channels. Data symbols to be transmitted are organized into blocks and a Fourier transform-based pre-processing method is then applied to the data blocks. Cyclic padding is then applied to the pre-processed blocks and each symbol in the padded block is then mapped to frequency subcarriers in specific time slots. The resulting signal is then transmitted through a wireless connection. At the receiver, the received signal is processed to thereby reverse the processing performed at the transmission end. As part of the reversal, a post-processing method is applied that reverses the effects of the pre-processing method.

In one aspect, the present invention provides a transmission system for processing incoming data for transmission to a receiver system by way of a wireless data link, the system comprising:
a modulator for receiving said data and for transforming said data into a plurality of complex valued symbols;
a block generator for organizing said plurality of data symbols into data blocks;
a pre-processing stage for applying a pre-processing method to said data blocks to produce pre-processed blocks;
a padding stage for adding cyclic padding to said pre-processed blocks to produce padded blocks;
a mapping stage for mapping each symbol in said padded blocks to frequency subcarriers such that each symbol in said padded block modulates a specific subcarrier in a specific time slot to produce a resulting transmit signal, said transmit signal being for transmission to said receiver system;
   wherein
   said pre-processing method is a Fourier transform-based method, effects of said pre-processing method being reversed by a post-processing method implemented on said receiver system which receives said transmit signal.

In another aspect, the present invention provides a receiver system for processing incoming wirelessly received signals from a transmission system by way of a wireless data link, the system comprising:
a de-mapping stage for extracting received symbols from a plurality of subcarriers in multiple time slots, said de-mapping stage producing a block of said received symbols;
a de-padding stage for removing cyclic padding from said block of received symbols to produce a de-padded block;
a post-processing stage for applying a post-processing method to said de-padded block to produce post-processed blocks;
an equalizer for compensating for fading on each symbol in said post-processed blocks;
a signal detector receiving an output of said equalizer, said signal detector being for detecting each of said symbols;
   wherein
said post-processing method is a Fourier transform-based method, said post-processing method being for reversing effects of a pre-processing method implemented on said transmission system which transmitted said received signals.

In a further aspect, the present invention provides a method for processing incoming data for transmission to a receiver system by way of a wireless data link, the method comprising:

a) modulating said data to transform said data into a plurality of complex valued symbols;
b) organizing said plurality of data symbols into data blocks;
c) applying a pre-processing stage to said data blocks to produce pre-processed blocks;
d) adding cyclic padding to said pre-processed blocks to produce padded blocks;
e) mapping each symbol in said padded blocks to frequency subcarriers such that each symbol in said padded block modulates a specific subcarrier in a specific time slot to produce a resulting transmit signal, said transmit signal being for transmission to said receiver system;
wherein
said pre-processing method is a Fourier transform-based method, effects of said pre-processing method being reversed by a post-processing method implemented on said receiver system which receives said transmit signal.

Yet another aspect of the invention provides a multiple antenna system implementing a multiple-input multiple output (MIMO) communications channel, said multiple antenna system having a plurality of transmission systems, at least one of said plurality of transmission systems being for processing incoming data for transmission to a receiver system by way of a wireless data link, said at least one transmission system comprising:
a modulator for receiving said data and for transforming said data into a plurality of complex valued symbols;
a block generator for organizing said plurality of data symbols into data blocks;
a pre-processing stage for applying a pre-processing method to said data blocks to produce pre-processed blocks;
a padding stage for adding cyclic padding to said pre-processed blocks to produce padded blocks;
a mapping stage for mapping each symbol in said padded blocks to frequency subcarriers such that each symbol in said padded block modulates a specific subcarrier in a specific time slot to produce a resulting transmit signal, said transmit signal being for transmission to said receiver system;
   wherein
   said pre-processing method is a Fourier transform-based method, effects of said pre-processing method being reversed by a post-processing method implemented on said receiver system which receives said transmit signal.

### BRIEF DESCRIPTION OF THE DRAWINGS

The embodiments of the present invention will now be described by reference to the following figures, in which:

FIG. 1 is a block representation of a communications system comprising a wireless transmitter and a wireless receiver configured according to one embodiment of the present invention;

FIG. 2 is a simplified example for a discrete delay-discrete frequency shift representation of a doubly-selective channel;

FIG. 3 graphically represents the structure of a padded block of symbols, obtained after transmit pre-processing and cyclic padding according the present invention. It also indicates and the correspondence of the rows and columns of the block, respectively, to frequency subcarriers and time slots;

FIG. 4 shows the circulant structure of the tensor representation of the effective channel [symbol] , corresponding to the doubly-selective channel illustrated in FIG. 2 with a block size of 4×4 being assumed;

FIG. 5 is a block diagram showing one implementation of the transmit pre-processing with frequency time block modulation according to of the present invention; and

FIG. 6 is a block diagram showing one implementation of the receiver post-processing with frequency time block modulation according to the present invention.

The Figures are not to scale and some features may be exaggerated or minimized to show details of particular elements while related elements may have been eliminated to prevent obscuring novel aspects. Therefore, specific structural and functional details disclosed herein are not to be interpreted as limiting but merely as a basis for the claims and as a representative basis for teaching one skilled in the art to variously employ the present invention.

### DETAILED DESCRIPTION OF THE INVENTION

The systems, methods, and devices corresponding to a signal processing technique for mitigating doubly-selective block fading in multicarrier wireless communications systems is described below.

The transmitter organizes a set of arbitrarily modulated data symbols into a data block having a block structure comprising rows and columns; a Fourier transform-based transmit pre-processing method is applied on it. A padded block is obtained by cyclic padding extra columns and rows to the resulting pre-processed block in the form of a cyclic prefix and cyclic bands. Next, subcarrier-symbol mapping causes each symbol in the padded block to modulate a pulse-shaped frequency subcarrier for a time slot, such that the rows and columns of the padded block correspond to successive subcarriers and time slots, respectively. The resulting signal is transmitted after frequency up-conversion and power amplification, as usual with RF transmitters.

The signal reaches the receiver over the wireless channel, supposedly undergoing doubly-selective block fading. After amplification, frequency down-conversion, and matched filtering as in conventional RF receivers, the received symbol corresponding to each subcarrier-time slot pair is extracted. Those symbols are arranged into a received block of symbols, after cyclic de-padding (i.e. after stripping away the rows and columns of symbols corresponding to the cyclic prefix and the cyclic bands). A Fourier transform-based receiver post-processing method is applied on the received block, reversing the effect of transmit pre-processing. The transmitted data is then determined by using the resulting post-processed block of symbols, after applying single-tap equalization on it as if each data symbol in the post-processed block were transmitted over an effective channel undergoing flat fading.

When the block sizes are properly chosen based on the channel, the transmit pre-processing and receiver post-processing, along with the cyclic padding/de-padding, have the effect of reducing a doubly-selective block fading channel into a plurality of flat fading effective channels.

The present invention provides multiple aspects of an invention relating to frequency time block modulation (FTBM), for multicarrier wireless communication. In one aspect, the invention provides a Fourier transform-based signal processing scheme, which is applied block-wise, at the transmitter and the receiver, on the data symbols conveyed over the radio propagation environment via a set of equi-spaced frequency subcarriers over multiple time slots. FTBM is effective against doubly-selective block fading.

Following acronyms are used in this description:
CSI—Channel State Information
DFT—Discrete Fourier Transform (N-DFT: DFT on N data elements)
FFT—Fast Fourier Transform
FTBM—Frequency Time Block Modulation
IDFT—Inverse Discrete Fourier Transform (N-IDFT: IDFT on N data elements)
IFFT—Inverse Fast Fourier Transform
MIMO—Multiple-Input Multiple-Output
OFDM—Orthogonal Frequency Division Multiplexing
RF—Radio Frequency

Following notation will be used throughout the description:

Aε [symbol] ^{M×N} is a complex M×N matrix (i.e., order-2 tensor). A(m,n) denotes the element in its (m,n) position (i.e., the n^{th} element on its m^{th} row), for mε{0, . . . , M−1} and nε{0, . . . , N−1}. [symbol] ε [symbol] ^{K×L×M×N} is a complex K×L×M×N order-4 tensor, whose element in its (k,l,m,n) position is denoted [symbol] (k,l,m,n), for kε{0, . . . , K−1}, lε{0, . . . , L−1}, mε{0, . . . , M−1}, and nε{0, . . . , N−1}. For notational simplicity, any reference to a matrix/tensor element using an index invalid for corresponding mode (e.g., A(M,0) is assumed to yield a zero (0) value.

Mode-p multiplication (see Section 2.2 of the Rezghi and Elden reference) of a tensor [symbol] and a conforming matrix A is defined as (A)ₚ· [symbol] . The notation (A,B)_{p,q}· [symbol] is shorthand for (B)_{q}·((A)ₚ· [symbol] ), where the matrices A and B have conforming dimensions. The contracting product (see Section 2.4 of the Rezghi and Elden reference) of [symbol] and a conforming matrix A, contracting modes {s₁,s₂} of [symbol] respectively with modes {1,2} of A, is denoted [symbol] ,A [symbol] _{{s}_{₁}_{,s}_{₂}_{}:{1,2}}. A^{H} is the conjugate transpose of A. Q_{N} denotes the rank-N DFT matrix (corresponding to N-DFT). [symbol] , [symbol] ⁺, and [symbol] ₀⁺ are the sets of integers, positive integers, and non-negative integers. |x| is the absolute value of a scalar x.

An M×N block of symbols has a logical block structure comprising M rows and N columns (as in a table). Such blocks are physically stored (e.g., in a random access memory) in such a way that each row/column of symbols can be independently retrieved and updated as dictated by relevant steps of the said method.

In this description, each block is represented by a matrix (from linear algebra), so that the steps of the various methods can be described precisely in terms of matrix operations (e.g., left-multiplication by Q_{N} represents applying N-DFT column-wise; right-multiplication denotes its row-wise application). The matrix representation also allows the validity of the said method to be proved using matrix and tensor operations. Table 1 lists each designated block used in this description and its corresponding matrix representation. For ease of reference, the various blocks listed in Table 1 have also been referenced by their reference numbers used in the Figures.

TABLE 1
Matrix representation of blocks of symbols.

| | Block | Matrix | |
|---|---|---|---|
| Block of symbols | Size | representation | |
| Data block 107 | M × N | | \tilde{D} ε [symbol] ^{M ×} ^{N} |

| | | |
|---|---|---|
| Pre-processed block 108 | M × N | D ε [symbol] ^{M ×} ^{N} |
| Padded block 300 | \hat{M} × \hat{N} | S ε [symbol] ^{\hat{M} ×\hat{N}} |
| Received block 157 | M × N | Y ε [symbol] ^{M ×} ^{N} |
| Post-processed block 158 | M × N | \tilde{Y} ε [symbol] ^{M ×} ^{N} |

The choice of the numbers M 307, N 306, \hat{M} 305, and \hat{N} 304 corresponding to the block sizes is described below.

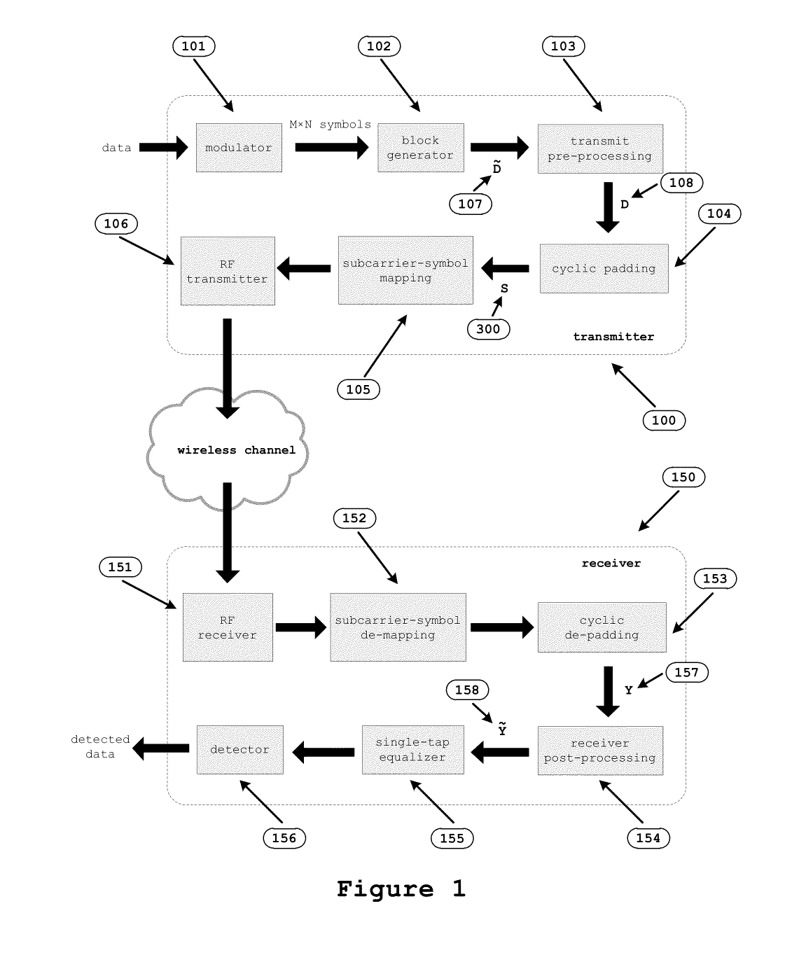

FIG. 1 is a block representation of a communication system containing a wireless transmitter and a wireless receiver configured according to one embodiment of the present invention. Only FTBM-related signal processing aspects of the transceivers are shown in the diagram. Other aspects, including channel estimation, synchronization and pulse shaping are omitted, as these specifics are known to those skilled in the art.

The FTBM transmitter 100 has several signal processing stages. The modulator 101 transforms the data to be transmitted into a sequence of complex valued symbols, as dictated by the desired modulation scheme. The block generator 102 organizes each successive group of M×N symbols into a data block \tilde{D}ε [symbol] ^{M×N} 107 with the data block having an M×N block structure. Subsequent FTBM signal processing happens block-by-block such that each data block is processed independently.

Next, a Fourier transform-based transmit pre-processing block 103 applies a method described below, causing each symbol of \tilde{D} to be mapped in a specific manner onto all the symbols of the method's output, pre-processed block Dε [symbol] ^{×N} 108. This mapping is reversible; in fact, receiver post-processing 154 reverses the mapping used in transmit pre-processing. Moreover, this mapping is independent of the channel state, and as a result, FTBM (just like OFDM) does not require CSI at the transmitter.

The cyclic padding stage 104 described below expands D by replicating certain columns and rows of D in the form of a cyclic prefix and two cyclic bands. Therefore, the resulting padded block Sε [symbol] ^{\hat{M}×\hat{N}} 300 has some redundancy, which lowers the spectral efficiency of FTBM. However, cyclic padding is crucial for ensuring that the effective channel can be diagonalized using Fourier transform-based transmit and receive processing.

The next stage performs the subcarrier-symbol mapping 105, i.e., varying the phase and the amplitude of each subcarrier based on, respectively, the angle and absolute the value of each symbol in S. Here, the symbols from each row of S pulse-amplitude modulate a distinct subcarrier in successive \hat{N} time slots. The symbols on each column of S dictate the phase and amplitudes of \hat{M} consecutive subcarriers for the corresponding time slot. The resulting baseband, multicarrier pulse-amplitude-modulated signal corresponds to a rectangular frequency-time lattice having subcarrier spacing Fₛ and symbol duration Tₛ. (μ=Fₛ·Tₛ is the density of the lattice.)

Conventionally, the RF transmitter stage 106 up-converts the resulting signal to the desired carrier frequency F_{c}, and feeds it to the transmit antenna after power amplification.

To summarize, each symbol S(m,n) modifies the amplitude and the phase of the m^{th} subcarrier, a possibly pulse-shaped sinusoid of frequency F_{c}+m·Fₛ for mε{0, . . . , \hat{M}−1} during the n^{th} time slot for nε{0, . . . , \hat{N}−1}. F_{c} is the carrier frequency. As usual with multicarrier communications, pulse shaping is realized by joint transmit and receive filtering. Since a block of M×N symbols \tilde{D} collectively modulates the frequency-time block that corresponds to \hat{M} subcarriers and \hat{N} time slots, the invention is referred to as frequency time block modulation.

At the FTBM receiver 150, the RF receiver stage 151 conventionally amplifies and down-converts the received signal. The subcarrier-symbol de-mapping stage 152 extracts the baseband signal received over each subcarrier in successive time slots, in the form of an \hat{M}×\hat{N} block of symbols; this extraction may be accomplished through matched filtering.

The symbols received over time slots and frequency subcarriers corresponding, respectively, to the cyclic prefix and cyclic bands are no longer required. (Those symbols have served their purpose by altering, as intended, the inter-carrier and inter-symbol interference caused by fading and transmit/receive filtering.) Cyclic de-padding stage 153 discards the corresponding rows and columns, forming the received block (or de-padded block) Yε [symbol] ^{M×N} 157.

Next, the received block Y undergoes receiver post-processing 154, which is a Fourier transform-based method reversing the particular transmit pre-processing scheme employed. A post-processed block of symbols \tilde{Y}ε [symbol] ^{M×N} 158 is produced.

Where the system parameters are appropriately chosen (as described below) to suit the channel, the relationship between respective elements of \tilde{D} and \tilde{Y} becomes one-to-one. More specifically, as shown below, the effective channel between \tilde{D} and \tilde{Y} has a {1,3},{2,4}-diagonal tensor representation [symbol] . A single-tap equalizer 155 can compensate for the overall effect of fading on each symbol by using the knowledge of [symbol] gained through channel estimation. After equalization, a conventional signal detector 156 detects the symbols one-by-one according to the modulation scheme employed at the transmitter.

In FIG. 1, a basic FTBM block diagram is illustrated where FTBM-specific signal processing is mostly implemented in the transmitter pre-processing 103, cyclic padding 104, receiver post-processing 154, and cyclic de-padding 153 stages.

The effect of doubly-selective fading in multicarrier transmission can be modeled using a discrete delay—discrete frequency shift domain representation, which reflects both the inter-symbol and inter-carrier interference it causes. If doubly-selective block fading is assumed, this representation is consistent within a certain frequency-time block B_{ft}—e.g. for a frequency band (fₒ,f₁) and a time duration (tₒ,t₁). If the subcarriers are also equi-spaced, this representation holds for all the subcarriers and every time slots falling within B_{ft}. Such representation depends not only on the scattering function, which characterizes the effect of doubly-selective fading on an unmodulated frequency carrier, but also on the symbol duration Tₛ, subcarrier spacing Fₛ, and pulse shaping.

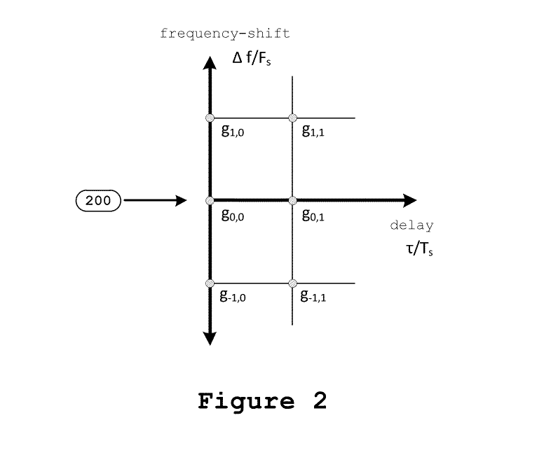

FIG. 2 is a discrete delay—discrete frequency shift representation of a channel. FIG. 2 provides a graphical representation of such discrete delay (τ)—discrete frequency shift (Δf) domain representation, where g_{i,j} 200 represents the overall channel response as a function of discrete frequency shift and discrete time delay. (The delay and frequency-shift axes are normalized with respect to Tₛ and Fₛ, respectively.)

Each g_{i,j} characterizes the interference caused by each symbol S(m,n) on the symbol S(m+i,n+j). The received block Yε [symbol] ^{M×N} 157 is thus related to S through g_{i,j}s by

$$Y ( m , n ) = {\sum }_{i = - ( {K}_{2} - 1 )}^{{K}_{1} - 1} {\sum }_{j = 0}^{L - 1} {g}_{i , j} \cdot S ( m - i , n - j ) + N ( m , n ) , \qquad Eqn . ( 1 )$$

for mε{0, . . . , M−1} and nε{0, . . . , N−1}. Nε [symbol] ^{M×N} is the additive noise. Eqn. (1) represents a convolutional channel response both in frequency and time domains.

The coefficients |g_{i,j}| decay with increasing |i| and j. The decay rate with increasing |i| is low because the pulse shaped subcarriers have time limited waveforms that tend to decay slowly in the frequency-domain. Nevertheless, for practical purposes, the range of significant |g_{i,j}| is presumably limited to iε{(K₂−1), . . . , K₁−1} and jε{0, . . . , L−1}, where L, K₁, K₂ε [symbol] ⁺ are reasonably small.

The example in FIG. 2 assumes that a transmitted symbol interferes with just the adjacent subcarriers and the immediately following symbol duration. Thus, K₁=K₂=L=2 and g_{i,j} is non-zero for only six (i,j) pairs: iε{−1,0,1} and jε{0,1}. Practical channel representations typically have larger, but finite K₁, K₂ and L. Only flat fading channels have K₁=K₂=L=1.

Traditionally, pulse shapes are chosen to ensure orthogonality and bi-orthogonality conditions, so that the interference caused on the detection of each symbol in the frequency-time lattice is suppressed for as many neighboring symbols as possible (e.g., by forcing corresponding g_{i,j}s to be zero). This approach restricts the choice of pulse shapes. Moreover, relying on orthogonal reception makes multicarrier communications system susceptible to doubly-selective fading, irrespective of the pulse shape chosen.

Pulse shaping for FTBM represents a paradigm shift; the focus is on making L, K₁, and K₂ small, so that |g_{i,j}|s decay faster. Orthogonal reception is no longer of concern, since FTBM processing takes the presence of the inter-symbol and inter-carrier interference for granted. Moreover, this approach also makes FTBM suitable for Faster than Nyquist signalling where ρ=Fₛ·Tₛ<1, in addition to usual Nyquist signaling (where ρ=1).

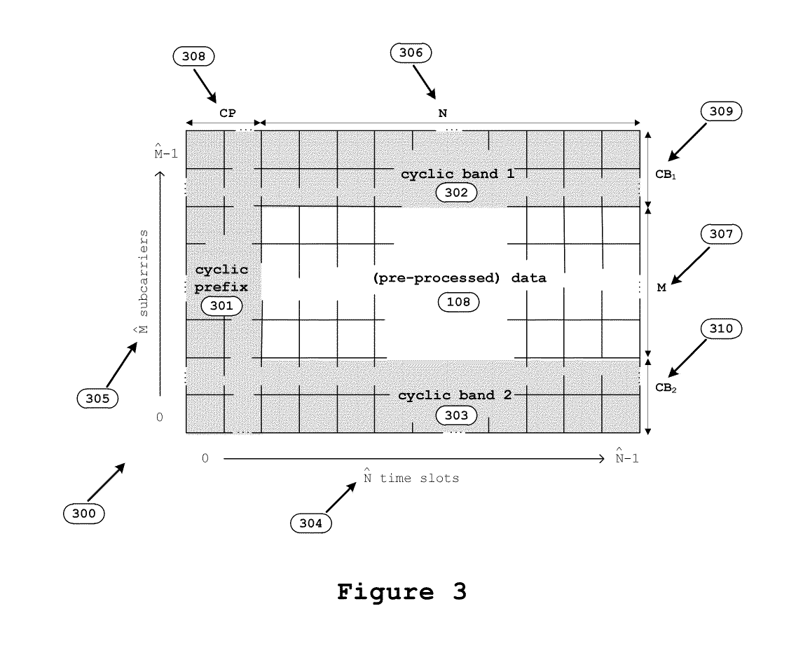

Referring to FIG. 3, illustrated is a padded block of symbols(after transmit pre-processing and cyclic padding) and the correspondence of its rows/columns to subcarriers/time slots. This diagram shows the structure of the padded block Sε [symbol] ^{\hat{M}×\hat{N}}300. Cyclic padding expands the pre-processed block Dε [symbol] ^{M×N}by adding a cyclic prefix 301 of length CP 308, and two cyclic bands 302, 303 of respective widths CB₁ 309 and CB₂ 310.

The cyclic-prefix length and cyclic-band widths are chosen such that CP≧L, CB₁≧K₁, and CB₂≧K₂, while ensuring that N>CP and M>CB₁+CB₂. This results in \hat{M}=M+CB₁+CB₂ 305 and \hat{N}=N+CP 304. The ratio M·N/\hat{M}·\hat{N} quantifies the rate loss owing to cyclic padding; hence it is desirable to have N>>CP and M>>CB₁+CB₂.

Moreover, if the channel response is consistent only within a frequency-time block B_{ft} corresponding to a frequency band (fₒ, f₁) and a time duration (tₒ,t₁), the parameters Fₛ, Tₛ,\hat{M}, and \hat{N} need to be chosen such that Fₛ·\hat{M}<(f₁−f₀) and Tₛ·\hat{N}<(t₁−t₀).

Following mapping between D and S defines the cyclic padding operation.

$$S ( i , j ) = \{ \begin{matrix}D ( \begin{matrix}M + i - {CB}_{2} , \\ N + j - CP\end{matrix} ) , & 0 \leq i < {CB}_{2} , 0 \leq j < CP \\ D ( M + i - {CB}_{2} , j - CP ) , & 0 \leq i < {CB}_{2} , CP \leq j < \hat{N} \\ D ( i - {CB}_{2} , N + j - CP ) , & \begin{matrix}{CB}_{2} \leq i < {CB}_{2} + M , \\ 0 \leq j < CP\end{matrix} \\ D ( i - {CB}_{2} , j - CP ) , & \begin{matrix}{CB}_{2} \leq i < {CB}_{2} + M , \\ CP \leq j < \hat{N}\end{matrix} \\ D ( \begin{matrix}i - {CB}_{2} - M , \\ N + j - CP\end{matrix} ) , & \begin{matrix}{CB}_{2} + M \leq i < \hat{M} , \\ 0 \leq j < CP\end{matrix} \\ D ( \begin{matrix}i - {CB}_{2} - M , \\ j - CP\end{matrix} ) , & {CB}_{2} + M \leq i < \hat{M} , CP \leq j < \hat{N} ,\end{matrix} \\ for i ∈ \{ 0 , … , \hat{M} - 1 \} \\ and \\ j ∈ \{ 0 , … , \hat{N} - 1 \} . \qquad Eqn . ( 2 )$$

Clearly, D remains as a sub-matrix within S. Other symbols in S, corresponding to the shaded region of the illustrated padded block 300, are redundant. However, these other symbols complete the cyclic structure and this is useful for altering the effective channel response.

The cyclic structure of S and the convolution in Eqn. (1) cause the relationship between D and Y to be given by

Y= [symbol] ,D [symbol] _{{3.4}:{1,2}}+N, Eqn. (3)

where [symbol] ε [symbol] ^{M×N×M×N} is a {1,3},{2,4}-circulant order-4 tensor.

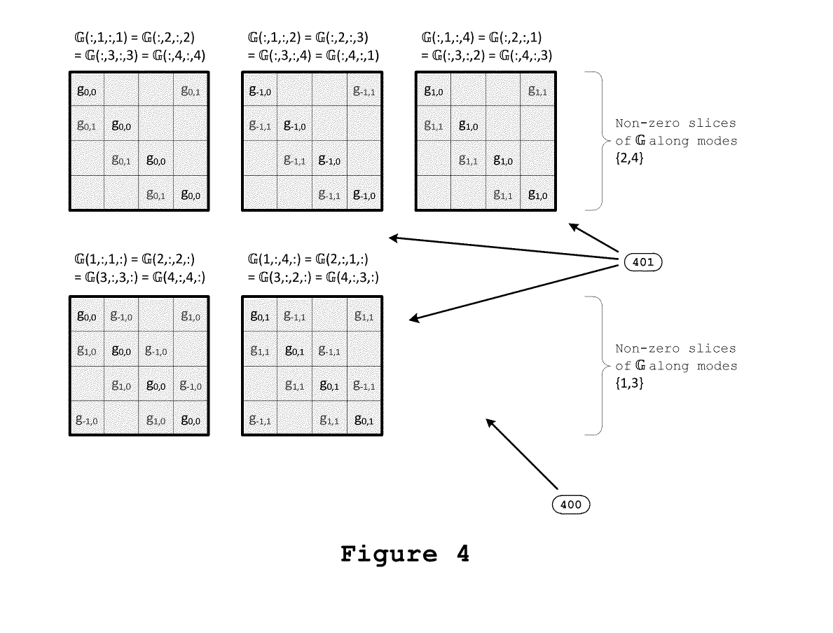

Referring to FIG. 4, illustrated is the circulant structure of the tensor representation of the effective channel [symbol] . In FIG. 4, the slices 401 of the tensor [symbol] 400 corresponding to g_{i,j} 200 in FIG. 2 are shown. Clearly, each non-zero slice is a circulant matrix; each slice along the mode-pair (1,3) corresponds to a column of g_{i,j}, and those along mode-pair (2,4), to rows of g_{i,j}.

A circulant tensor can always be diagonalized along the corresponding modes by using suitable discrete Fourier transforms (see Section 5.1 of the Rezghi and Elden reference). Therefore, the following set of transforms yields a {1,3},{2,4}-diagonal tensor [symbol] :

[symbol]

=(\tilde{Q}_{T},\tilde{Q}_{T}^{H})_{2,4}·((\tilde{Q}_{F},\tilde{Q}_{F}^{H})_{1,3}· [symbol] ), Eqn. (4)

where \tilde{Q}_{F}ε{Q_{M},Q_{M}^{H}} and \tilde{Q}_{T}ε{Q_{N},Q_{N}^{H}}. Note that each matrix \tilde{Q}_{F} and \tilde{Q}_{T} can represent either the DFT or IDFT; therefore, there are four possible realizations of Eqn. (4).

The non-zero elements of [symbol] an be perceived to lie on an M×N plane in an M×N×M×N discrete 4-dimensional hyperspace.

Define \tilde{Y} [symbol] ^{M×N} and \tilde{D}ε [symbol] ^{M×N}, respectively, in terms of \tilde{Y}ε [symbol] ^{M×N} and Dε [symbol] ^{M×N}, such that

D=\tilde{Q}_{F}^{H}·\tilde{D}·\tilde{Q}_{T}^{H}, Eqn. (5)

\tilde{Y}=\tilde{Q}_{F}·Y·\tilde{Q}_{T}. Eqn. (6)

By substituting Eqn. (5) and Eqn. (6) into Eqn. (3) and simplifying the result using the first principles we get

\tilde{Y}= [symbol] ,\tilde{D} [symbol] _{{3.4}:{1,2}}+\tilde{Q}_{F}·N·\tilde{Q}_{T}, Eqn. (7)

where [symbol] is the tensor given by Eqn. (4).

Since [symbol] is {1,3},{2,4}-diagonal, we have

\tilde{Y}(m,n)= [symbol] (m,n,m,n)×\tilde{D}(m,n)+Ñ(m,n), Eqn. (8)

for mε{0, . . . , M−1} and nε{0, . . . , N−1}, where Ñ=\tilde{Q}_{F}·N·\tilde{Q}_{T}. Clearly, there is a one-to-one correspondence between the elements of \tilde{D} and \tilde{Y}.

The above equations imply that we can achieve a one-to-one correspondence between the data block \tilde{D} and the post-processed block \tilde{Y} by using the transformations given by Eqn. (5) and Eqn. (6), respectively, in the transmit pre-processing and receiver post-processing methods.

Since \tilde{Q}_{F}·(\tilde{Q}_{F}^{H}·A·\tilde{Q}_{T}^{H})·\tilde{Q}≡A for any matrix Aε [symbol] ^{M×N}, we can deduce that receiver post-processing always reverses the effect of transmit pre-processing.

According to Eqn. (5), \tilde{D} is pre-multiplied by \tilde{Q}_{F}^{H}, and post-multiplied by Q_{T}^{H}. In other words, either DFT or IDFT is applied column-wise and row-wise on the data block, as dictated by \tilde{Q}_{F}^{H} and \tilde{Q}_{T}^{H}, respectively. Since matrix multiplications are associative, pre- and post-multiplications can be applied successively in either order.

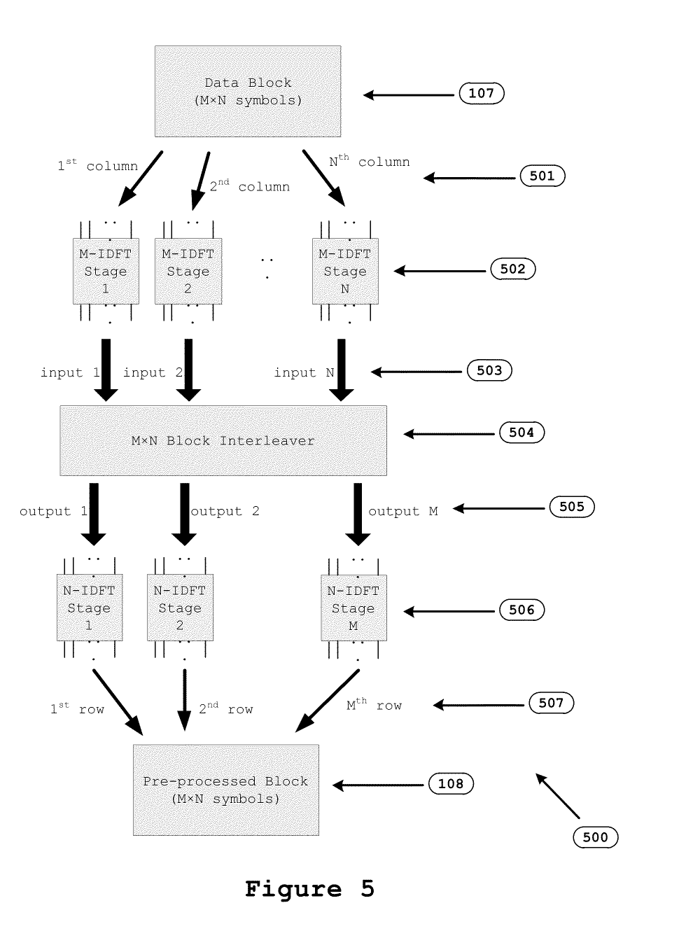

Referring to FIG. 5, a block diagram 500 of an implementation of Eqn. (5) for FTBM transmit pre-processing in accordance with one embodiment of the present invention (corresponding to \tilde{Q}_{F}≐Q_{M} and \tilde{Q}_{T}≐Q_{N}) is illustrated. Each of the N columns 501 of the data block \tilde{D}ε [symbol] ^{M×N} 107 is retrieved and input to N parallel M-IDFT stagesor sub-blocks 502; their output 503 is input to an M×N block interleaver 504. The M-IDFT stages or sub-blocks thus implement pre-multiplication by \tilde{Q}_{F}^{H}≐Q_{M}^{H}. The interleaver swaps the columns and rows of the resulting block of symbols, so that the post-multiplication can be implemented next. The interleaver output comprising M streams 505 is fed into M parallel N-IDFT stages or sub-blocks 506; these stages or sub-blocks implement post-multiplication by \tilde{Q}_{T}^{H}≐Q_{N}^{H}. Their output 507 is stored as the pre-processed block Dε [symbol] ^{M×N} 108.

It should be noted that the block interleaver 504 may be replaced by any block switching means. Any device or component which can switch rows and columns can be used in place of the interleaver.

The hardware implementation corresponding to FIG. 5 requires only M×N memory locations each capable of storing one symbol. A single hardware realization of the M-IDFT operation can successively implement all N parallel M-IDFT stages, by retrieving from the memory locations corresponding to successive columns and by updating those locations in-place with the corresponding output. Switching from accessing the memory locations by rows to accessing by columns (or vice versa) is equivalent to using the interleaver. As with the M-IDFT stages, the N-IDFT stages require only one hardware realization of the N-IDFT operations.

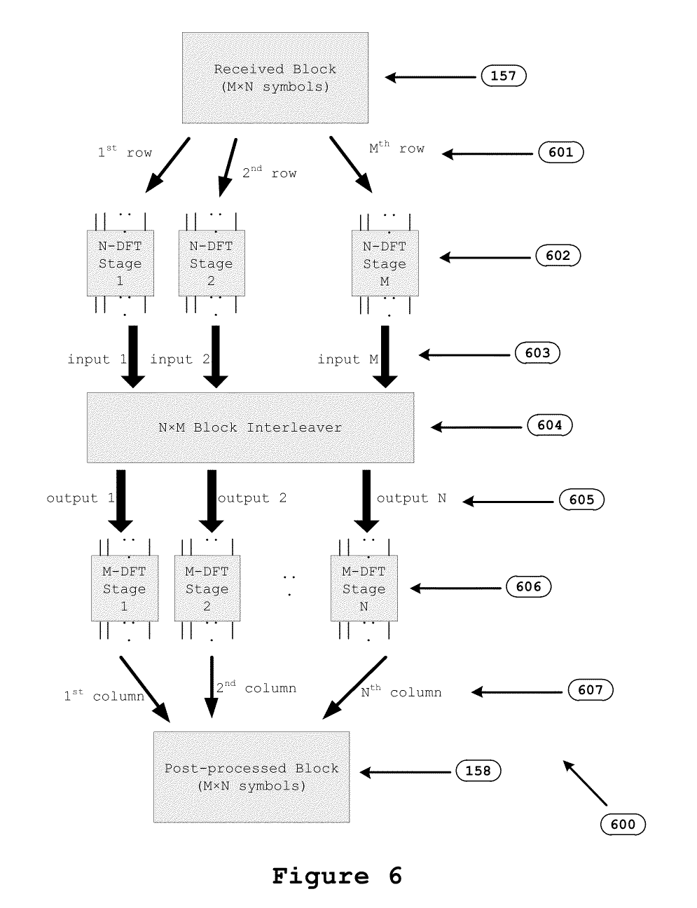

Referring to FIG. 6, a block diagram 600 of an implementation of Eqn. (5) for FTBM receiver post-processing in accordance with one embodiment of the present invention (corresponding to \tilde{Q}_{F}≐Q_{M} and \tilde{Q}_{T}≐Q_{N}) is illustrated. Each of the M rows 601 of the received block Yε [symbol] ^{M×N} 157 is retrieved and input to M parallel N-DFT stages 602. The output 603 of these stages is fed to an N×M block interleaver 604. The N-DFT stages thus implement post-multiplication by \tilde{Q}_{T}≐Q_{N}. The interleaver swaps the columns and rows of the resulting block of symbols, so that the pre-multiplication can be implemented next. The interleaver output comprising N streams 605 is fed into N parallel 114-DFT stages 606; these stages implement pre-multiplication by \tilde{Q}_{F}≐Q_{M}. Their output 607 is stored as the post-processed block \tilde{Y} [symbol] ^{M×N} 158. Hardware implementation of receiver post-processing is similar to that of transmit pre-processing.

Eqn. (5) becomes a two-dimensional IDFT for the case \tilde{Q}_{F}≐Q_{M},\tilde{Q}_{T}≐Q_{N}; similarly the case \tilde{Q}_{F}≐Q_{M}^{H},\tilde{Q}_{T} ≐Q_{N}^{H} corresponds to two-dimensional DFT. Therefore, Eqn. (6) becomes a two-dimensional DFT and two-dimensional IDFT for the respective cases.

In practice, DFT and IDFT operations are preferably implemented, respectively, using any FFT and IFFT algorithm. Similarly, two-dimensional FFT/IFFT algorithms can efficiently implement the two-dimensional Fourier transforms.

Referring to Eqn. (8), each non-zero {1,3},{2,4}-diagonal value [symbol] (m,n,m,n) is the effective channel gain corresponding to the transmission of symbol \tilde{D}(m,n) for mε{0, . . . , M−1} and nε{0, . . . , N−1}. Therefore, when the receiver has CSI, \tilde{D}(m,n) can be detected after single-tap equalization of \tilde{Y}(m,n).

According to Eqn. (8), the effective additive noise, which is responsible for detection errors, is given by Ñ(m,n). Interestingly, Ñ=\tilde{Q}hd T has the same random distribution as N, when N represents independent and identically distributed Gaussian noise (which is the commonly assumed noise distribution). This observation indicates that FTBM receiver processing does not cause noise enhancement.

Although, M×N non-zero elements exist in [symbol] , they are completely determined by, at most, L×(K₁+K₂−1)non-zero g_{i,j} values 200. Therefore, estimating L×(K₁+K₂−1)<<M×N non-zero elements of [symbol] is sufficient to gain complete channel knowledge. (Remaining elements can be interpolated.) This fact could be useful in pilot design (e.g. placement of pilots amidst data) for channel estimation.

Consider a multiple-antenna system comprising N_{T} transmit antennas and N_{R} receive antennas; the corresponding multiple-input multiple-output (MIMO) channel has N_{T}×N_{R} links each between a distinct antenna-pair: (t,r) for tε{1, . . . , N_{T}} and rε{1, . . . , N_{R}}. Under doubly-selective fading, the channel response corresponding to each link has the same form as Eqn. (1), with the g_{i,j}s as well as the value K₁, K₂, and L being different for each link. For ease of reference, one can use the superscript .^{(t,r)}, as with g_{i,j}^{(t,r)}, K₁^{(t,r)}, K₂^{(t,r)}, L^{(t,r)}, to differentiate between the antenna-pairs.

For such a system, one chooses the FTBM parameters M, N, \hat{M}, and \hat{N} to satisfy the criteria noted above regarding pulse shaping for all the antenna pairs. One can then implement independent FTBM transmit processing for each transmit antenna by using the same choice of \tilde{Q}_{F} and \tilde{Q}_{T}. Similarly, one can then implement independent FTBM receiver processing for each receiver antenna.

By using the superscripts .^{(t)} and .^{(r)}, respectively, to distinguish the blocks of symbols corresponding transmit antennas and receive antennas, we get \tilde{D}^{(t)}ε [symbol] ^{M×N}, D^{(t)}ε [symbol] ^{M×N}, S^{(t)}ε [symbol] ^{\hat{M}×\hat{N}}, Y^{(r)}ε [symbol] ^{M×N}, and \tilde{Y}^{(r)}ε [symbol] ^{M×N} for t ε{1, . . . , N_{T}} and rε{1, . . . , N_{R}}.

Thus, as with Eqn. (1), we get

$${Y}^{( r )} ( m , n ) = {\sum }_{t = 1}^{{N}_{T}} {\sum }_{i = - ( {K}_{2}^{( t , r )} - 1 )}^{{K}_{1}^{( t , r )} - 1} {\sum }_{j = 0}^{{L}^{( t , r )} - 1} {g}_{i , j}^{( t , r )} \cdot {S}^{( t )} ( m - i , n - j ) + {N}^{( r )} ( m , n ) , \qquad Eqn . ( 9 )$$

for mε{0, . . . , M−1}, nε{0, . . . , N−1} and rε{1, . . . , N_{R}}. N^{(r)}ε [symbol] ^{M×N} represents the additive noise. Since D^{(t)}ε [symbol] ^{M×N} and S^{(t)}ε [symbol] ^{\hat{M}×\hat{N}} have the same mapping as that given by Eqn. (2), we get

$${Y}^{( r )} = {\sum }_{t = 1}^{{N}_{T}} {〈 {𝔾}^{( t , r )} , {D}^{( t )} 〉}_{\{ 3 , 4 \} \text{:} \{ 1 , 2 \}} + {N}^{( r )} , \qquad Eqn . ( 10 )$$

where [symbol] ^{(t,r)}ε [symbol] ^{M×N×M×N} is a {1,3},{2,4}-circulant order-4 tensor, representing the effective channel for (t,r) antenna-pair. Since matrix and tensor operators are linear, Eqn. (10) can be transformed (as with the single-antenna systems) to get

$${\tilde{Y}}^{( r )} ( m , n ) = {\sum }_{t = 1}^{{N}_{T}} {( t , r )}^{} ( m , n , m , n ) \times {\tilde{D}}^{( t )} ( m , n ) + {\tilde{N}}^{( r )} ( m , n ) , \\ where \\ {\tilde{N}}^{( r )} = {\tilde{Q}}_{F} \cdot {N}^{( r )} \cdot {\tilde{Q}}_{T} \\ and \\ {( t , r )}^{} = {( {\tilde{Q}}_{T} , {\tilde{Q}}_{T}^{H} )}_{2 , 4} \cdot ( {( {\tilde{Q}}_{F} , {\tilde{Q}}_{F}^{H} )}_{1 , 3} \cdot {( t , r )}^{} ) , \\ for m ∈ \{ 0 , … , M - 1 \} , \\ n ∈ \{ 0 , … , N - 1 \} , \\ and \\ r ∈ \{ 1 , … , {N}_{R} \} . \qquad Eqn . ( 11 )$$

The coefficients [symbol] ^{(t,r)}(m,n,m,n) for tε{1, . . . , N_{T}} and rε{1, . . . , N_{R}} represent a MIMO channel undergoing flat fading. Corresponding channel matrix H_{m,n}ε [symbol] ^{N}^{_{R}}^{×N}^{_{T}} is given by H_{m,n}(r,t)≐ [symbol] H^{(t,r)}(m,n,m,n); arbitrary MIMO signal processing technique may be employed (on top of FTBM) to exploit each H_{m,n}.

Therefore, by independently employing identical FTBM transmit and receive processing, respectively, at transmit and receive antennas, a MIMO doubly-selective channel can be reduced into a plurality of MIMO flat channels. This result is intuitive because FTBM processing does not depend on the channel state and the space dimension is orthogonal to time and frequency dimensions.

Note that the above discussion does not assume that the N_{T} transmit antennas or the N_{R} receive antennas are necessarily collocated. They may as well be located at multiple users; therefore, FTBM is equally applicable for multiuser MIMO downlink (multicast) channels, and with proper synchronization, for multiuser MIMO uplink (multiple-access) channels.

Further clarity or background information may be found by referring to:
Pandharipande, A. (2002). Principles of OFDM. IEEE Potentials, 21(2):16-19.
Rezghi, M. and Elden, L. (2011). Diagonalization of tensors with circulant structure. Linear Algebra and its Applications, (447):422-447.

The contents of the above references are incorporated herein by reference.

The method steps of the invention may be embodied in sets of executable machine code stored in a variety of formats such as object code or source code. Such code is described generically herein as programming code, or a computer program for simplification. Clearly, the executable machine code may be integrated with the code of other programs, implemented as subroutines, by external program calls or by other techniques as known in the art.

The embodiments of the invention may be executed by a computer processor or similar device programmed in the manner of method steps, or may be executed by an electronic system which is provided with means for executing these steps. Similarly, an electronic memory means such computer diskettes, CD-ROMs, Random Access Memory (RAM), Read Only Memory (ROM) or similar computer software storage media known in the art, may be programmed to execute such method steps. As well, electronic signals representing these method steps may also be transmitted via a communication network.

Embodiments of the invention may be implemented in any conventional computer programming language. For example, preferred embodiments may be implemented in a procedural programming language (e.g.“C”) or an object oriented language (e.g.“C++”). Alternative embodiments of the invention may be implemented as pre-programmed hardware elements, other related components, or as a combination of hardware and software components. Embodiments can be implemented as a computer program product for use with a computer system. Such implementations may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or electrical communications lines) or a medium implemented with wireless techniques (e.g., microwave, infrared or other transmission techniques). The series of computer instructions embodies all or part of the functionality previously described herein. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink wrapped software), preloaded with a computer system (e.g., on system ROM or fixed disk), or distributed from a server over the network (e.g., the Internet or World Wide Web). Of course, some embodiments of the invention may be implemented as a combination of both software (e.g., a computer program product) and hardware. Still other embodiments of the invention may be implemented as entirely hardware, or entirely software (e.g., a computer program product).

A person understanding this invention may now conceive of alternative structures and embodiments or variations of the above all of which are intended to fall within the scope of the invention as defined in the claims that follow.

We claim:

1. A transmission system for processing incoming data for transmission to a receiver system by way of a wireless data link, the system comprising:
a modulator for receiving said data and for transforming said data into a plurality of complex valued symbols;
a block generator for organizing said plurality of data symbols into data blocks;
a pre-processing stage for applying a pre-processing method to said data blocks to produce pre-processed blocks;
a padding stage for adding cyclic padding to said pre-processed blocks to produce padded blocks;
a mapping stage for mapping each symbol in said padded blocks to frequency subcarriers such that each symbol in said padded block modulates a specific subcarrier in a specific time slot to produce a resulting transmit signal, said transmit signal being for transmission to said receiver system;
wherein
said pre-processing method is a Fourier transform-based method, effects of said pre-processing method being reversed by a post-processing method implemented on said receiver system which receives said transmit signal.

2. A system according to claim 1 wherein said pre-processing method comprises:
applying a Fourier transform-based process to each symbol in said data blocks in a row-wise and a column-wise manner.

3. A system according to claim 2 wherein said Fourier transform-based process is a discrete Fourier transform.

4. A system according to claim 2 wherein said Fourier transform-based process is an inverse discrete Fourier transform.

5. A system according to claim 1 wherein said cyclic padding comprises a cyclic prefix and two cyclic bands.

6. A system according to claim 1 wherein said pre-processing stage comprises a block interleaver for switching columns and rows in said data blocks.

7. A system according to claim 1 wherein said pre-processing stage comprises a block switching means for switching columns and rows in said data blocks.

8. A system according to claim 1 wherein said preprocessing stage comprises a plurality of sub-blocks for applying a discrete Fourier transform to symbols in said data blocks.

9. A system according to claim 8 wherein each one of said plurality of sub-blocks receives said symbols in a column-wise manner.

10. A system according to claim 8 wherein each one of said plurality of sub-blocks receives said symbols in a row-wise manner.

11. A system according to claim 1 wherein said pre-processing stage comprises a plurality of sub-blocks for applying an inverse discrete Fourier transform to symbols in said data blocks.

12. A system according to claim 11 wherein each one of said plurality of sub-blocks receives said symbols in a column-wise manner.

13. A system according to claim 11 wherein each one of said plurality of sub-blocks receives said symbols in a row-wise manner.

14. A system according to claim 1 wherein said system is used in a multiple-antenna system which implements a multiple-input multiple-output (MIMO) channel.

15. A system according to claim 1 wherein said receiver system comprises:
a de-mapping stage for extracting received symbols from a plurality of subcarriers in multiple time slots, said de-mapping stage producing a block of said received symbols;
a de-padding stage for removing cyclic padding from said block of received symbols to produce a de-padded block;
a post-processing stage for applying a post-processing method to said de-padded block to produce post-processed blocks;
an equalizer for compensating for fading on each symbol in said post-processed blocks;
a signal detector receiving an output of said equalizer, said signal detector being for detecting each of said symbols;
wherein
said post-processing method is a Fourier transform-based method, said post-processing method being for reversing effects of said pre-processing method.

16. A receiver system for processing incoming wirelessly received signals from a transmission system by way of a wireless data link, the system comprising:
a de-mapping stage for extracting received symbols from a plurality of subcarriers in multiple time slots, said de-mapping stage producing a block of said received symbols;
a de-padding stage for removing cyclic padding from said block of received symbols to produce a de-padded block;
a post-processing stage for applying a post-processing method to said de-padded block to produce post-processed blocks;
an equalizer for compensating for fading on each symbol in said post-processed blocks;
a signal detector receiving an output of said equalizer, said signal detector being for detecting each of said symbols;
wherein
said post-processing method is a Fourier transform-based method, said post-processing method being for reversing effects of a pre-processing method implemented on said transmission system which transmitted said received signals.

17. A system according to claim 16 wherein said transmission system comprises:
a modulator for receiving data to be transmitted and for transforming said data into a plurality of complex valued symbols;
a block generator for organizing said plurality of data symbols into data blocks;
a pre-processing stage for applying said pre-processing method to said data blocks to produce pre-processed blocks;
a padding stage for adding cyclic padding to said pre-processed blocks to produce padded blocks;
a mapping stage for mapping each symbol in said padded blocks to frequency subcarriers such that each symbol in said padded block modulates a specific subcarrier in a specific time slot to produce a resulting transmit signal, said transmit signal being for transmission to said receiver system.

18. A system according to claim 16 wherein said post-processing method comprises:
applying a Fourier transform-based process to each symbol in said data blocks in a row-wise and a column-wise manner.

19. A system according to claim 16 wherein said post-processing method applies an inverse of a Fourier transform applied by said pre-processing method.

20. A method for processing incoming data for transmission to a receiver system by way of a wireless data link, the method comprising:
a) modulating said data to transform said data into a plurality of complex valued symbols;
b) organizing said plurality of data symbols into data blocks;
c) applying a pre-processing stage to said data blocks to produce pre-processed blocks;
d) adding cyclic padding to said pre-processed blocks to produce padded blocks;
e) mapping each symbol in said padded blocks to frequency subcarriers such that each symbol in said padded block modulates a specific subcarrier in a specific time slot to produce a resulting transmit signal, said transmit signal being for transmission to said receiver system;
wherein
said pre-processing method is a Fourier transform-based method, effects of said pre-processing method being reversed by a post-processing method implemented on said receiver system which receives said transmit signal.

21. A method according to claim 20 wherein, at said receiver system, said transmit signal is received by said receiver system and processed according to a method comprising:
f) extracting received symbols from a plurality of subcarriers in multiple time slots to produce a block of received symbols;
g) removing cyclic padding from said block of received symbols to produce a de-padded block;
h) applying a post-processing method to said de-padded block to produce post-processed blocks;
i) compensating for fading on each symbol in said post-processed blocks;
j) detecting each of said symbols;
wherein
said post-processing method reverses effects of said pre-processing method.

22. A multiple antenna system implementing a multiple-input multiple output (MIMO) communications channel, said multiple antenna system having a plurality of transmission systems, at least one of said plurality of transmissions systems being for processing incoming data for transmission to a receiver system by way of a wireless data link, said at least one transmission system comprising:
a modulator for receiving said data and for transforming said data into a plurality of complex valued symbols;
a block generator for organizing said plurality of data symbols into data blocks;
a pre-processing stage for applying a pre-processing method to said data blocks to produce pre-processed blocks;
a padding stage for adding cyclic padding to said pre-processed blocks to produce padded blocks;
a mapping stage for mapping each symbol in said padded blocks to frequency subcarriers such that each symbol in said padded block modulates a specific subcarrier in a specific time slot to produce a resulting transmit signal, said transmit signal being for transmission to said receiver system;
wherein
said pre-processing method is a Fourier transform-based method, effects of said pre-processing method being reversed by a post-processing method implemented on said receiver system which receives said transmit signal.
